(19) United States
(12) Patent Application Publication
(10) Pub. No.: US 2008/0046778 A1
(43) Pub. Date: Feb. 21, 2008

(54) MEMORY CONTROLLER AND SEMICONDUCTOR MEMORY DEVICE

(76) Inventor: Norikazu YOSHIDA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/770,320

(22) Filed: Jun. 28, 2007

(30) Foreign Application Priority Data
Jun. 30, 2006 (JP) 2006-182633

(51) Int. Cl. G06F 11/00

(52) U.S. Cl. 714/5; 714/E11.001

(57) ABSTRACT

When data-read from a memory is a data moving process in the memory, a correction process is omitted in a case where the number of errors is less than a threshold value or the threshold value or less, and the correction process is executed in a case where the number of errors is the threshold value or more, or greater than the threshold value.

### CROSS-REFERENCE TO RELATED APPLICATIONS

This application is based upon and claims the benefit of priority from prior Japanese Patent Application No. 2006-182633, filed Jun. 30, 2006, the entire contents of which are incorporated herein by reference.

### BACKGROUND OF THE INVENTION

1. Field of the Invention

The present invention relates generally to a memory controller and a semiconductor memory device, and relates, for example, to a memory card including a memory controller which performs a data moving process.

2. Description of the Related Art

In recent years, with rapid prevalence of digital cameras, portable audio players, etc., there has been an increasing demand for large-capacity nonvolatile semiconductor memories. NAND-type flash memories have widely been used as such nonvolatile semiconductor memories.

In the NAND-type flash memory, data in a plurality of memory cells is batch-erased. The unit of erase is called “memory block”. In the NAND-type flash memory, overwrite of data cannot be executed for reasons of its characteristics. Thus, when data is to be updated, update data has to be newly written in a memory block in which data erasure has already been executed. As regards non-updated data, it is necessary to read out the non-updated data out from a memory block in which the data before update is written, and to write back the read-out non-updated data into the block in which the update data has been written. This operation is called a “data moving process” in this specification. The data moving process is started according to a page copy command.

In a conventional technique, when the data moving process using the page copy command is to be executed, if an ECC error in the read-out data is detected, a memory controller corrects the error of the data, sends the error-corrected data to the NAND-type flash memory, and writes back the error-corrected data into the block in which update data has been written.

With development in microfabrication of the NAND-type flash memory, there is a tendency that the probability of occurrence of errors increases. Even in the case where the page copy command, which normally enables a high-speed data moving process, is used, re-input of data for error correction frequently occurs, and a desired high-speed performance cannot be realized.

### BRIEF SUMMARY OF THE INVENTION

According to an aspect of the present invention, there is provided a memory controller which is connectable to a memory and controls the memory, comprising: a memory interface to which read-out data from the memory and an ECC parity of the read-out data are input; an ECC core to which the read-out data and the ECC parity are input from the memory interface, and which generates, on the basis of the ECC parity, information of presence/absence of an error in the read-out data and correction information of the error; and a buffer to which the correction information and the read-out data from the memory interface are input, and executes a correction process of correcting the read-out data in accordance with the correction information in a case where the error is present in the read-out data, wherein when data-read from the memory is a data moving process in the memory, the correction process is omitted in a case where a number of the errors is less than a threshold value or the threshold value or less and the read-out data including the error is written back into the memory, and the correction process is executed in a case where the number of the errors is the threshold value or more, or greater than the threshold value and the read-out data, which has been subjected to the correction process, is written back into the memory.

According to an aspect of the present invention, there is provided a semiconductor memory device comprising: a memory, and a memory controller which is connectable to the memory and controls the memory, the memory controller comprising, a memory interface to which read-out data from the memory and an ECC parity of the read-out data are input, an ECC core to which the read-out data and the ECC parity are input from the memory interface, and which generates, on the basis of the ECC parity, information of presence/absence of an error in the read-out data and correction information of the error, and a buffer to which the correction information and the read-out data from the memory interface are input, and executes a correction process of correcting the read-out data in accordance with the correction information in a case where the error is present in the read-out data, wherein when data-read from the memory is a data moving process in the memory, the correction process is omitted in a case where a number of the errors is less than a threshold value or the threshold value or less, and the correction process is executed in a case where the number of the errors is the threshold value or more, or greater than the threshold value.

### BRIEF DESCRIPTION OF THE SEVERAL VIEWS OF THE DRAWING

FIG. 1 shows an example of a memory card;

FIG. 2 shows an example of signal assignment in the memory card;

FIG. 3 is a block diagram showing an example of a hardware structure of the memory card;

FIG. 4 shows an example of a page format which is used in the memory card;

FIG. 5 is a flow chart illustrating a first example of a data moving process sequence which is executed by a memory controller according to a first embodiment of the invention;

FIG. 6 shows an example of data input/output in the case where a write-back process is executed in units of a page;

FIG. 7 is a flow chart illustrating a second example of the data moving process sequence which is executed by the memory controller according to the first embodiment of the invention; and

FIG. 8 is a flow chart illustrating an example of a threshold variation setting sequence which is executed by a memory controller according to a second embodiment of the invention.

### DETAILED DESCRIPTION OF THE INVENTION

Embodiments of the present invention will now be described with reference to the accompanying drawings. In the description, common parts are denoted by like reference numerals throughout the drawings.

### First Embodiment

A first embodiment of the present invention is described by taking, as an example, an electronic device, such as a memory card, which incorporates a memory controller. To begin with, an example of a memory card, to which the invention is applicable, is described.

### EXAMPLE OF MEMORY CARD

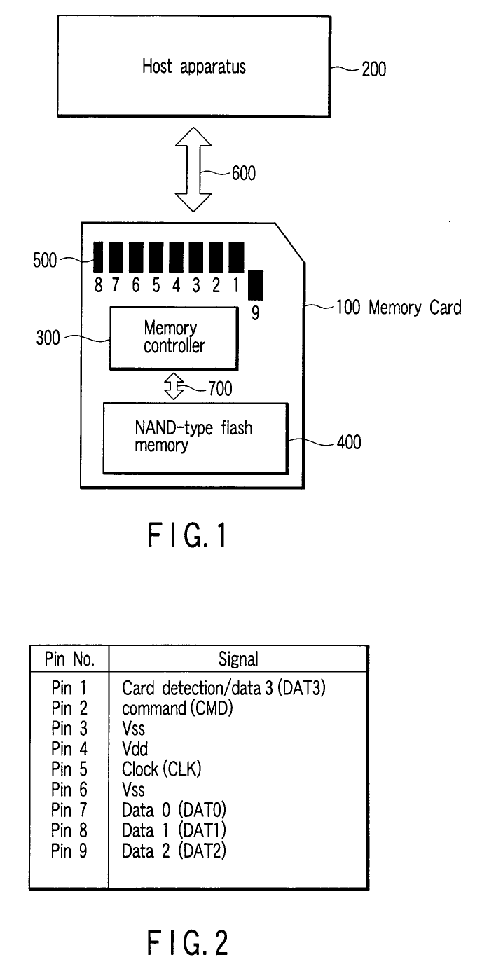

FIG. 1 shows an example of the memory card.

As shown in FIG. 1, the memory card 100 transmits/receives data to/from a host apparatus 200 via a bus interface 600. The memory card 100 is configured to be insertable in a slot formed in the host apparatus 200.

The memory card 100 includes a memory controller 300, a nonvolatile semiconductor memory (hereinafter referred to as “flash memory”) 400 and a card terminal 500.

The memory controller 300 controls the flash memory 400. An example of the flash memory 400 is a NAND-type flash memory.

The card terminal 500 is a signal pin that is electrically connected to the memory controller 300, and functions as an external pin of the memory card 100. The card terminal 500 in this embodiment comprises a plurality of signal pins (first to ninth pins). FIG. 2 shows an example of signal assignment to the first pin to the ninth pin.

As shown in FIG. 2, data 0 to data 3 are assigned to the seventh pin, eighth pin, ninth pin and first pin. The first pin is assigned not only to the data 3, but also to a card detection signal. The second pin is assigned to a command. The third pin and sixth pin are assigned to a ground potential Vss. The fourth pin is assigned to a power supply potential Vdd, and the fifth pin is assigned to a clock signal.

The external terminal 500 and bus interface 600 are used for communication between a host apparatus controller (not shown) in the host apparatus 200 and the memory card 100. For example, the host apparatus controller communicates various signals and data with the memory controller 300 in the memory card 100 via the first to ninth pins. For example, when data is to be written in the memory card 100, the host apparatus controller transmits a write command to the memory controller 300 via the second pin. At this time, in response to the clock signal that is supplied to the fifth pin, the memory controller 300 receives the write command that is delivered to the second pin. The second pin, which is assigned to the input of the command, is disposed between the first pin for the data 3 and the third pin for the ground potential Vss.

On the other hand, communication between the memory controller 300 and flash memory 400 is executed via an IO line (data line) 700 of, e.g. 8 bits.

When the memory controller 300 writes data in the flash memory 400, the memory controller 300 successively inputs a data input command 80h, a column address, a page address, data and a program command 10h to the flash memory 400 via the IO line 700. The symbol “h” of the command 80h indicates a hexadecimal number. Actually, an 8-bit signal “10000000” is delivered in parallel to the 8-bit IO line 700. In addition, the transmission of the command to the flash memory 400 and the transmission/reception of the data are executed by commonly using the IO line 700.

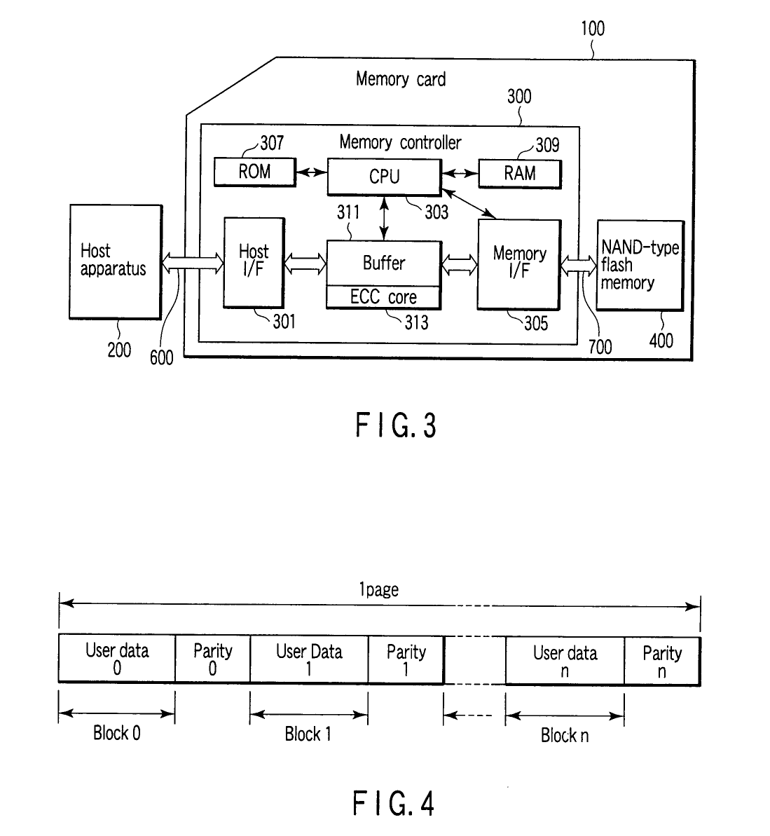

FIG. 3 is a block diagram of an example of the hardware structure of the memory card.

The host apparatus 200 includes hardware and software for accessing the memory card 100. Examples of the host apparatus 200 are a mobile phone, a digital camera (video camera, still camera), audio equipment, audio/video equipment, a game machine, an electronic musical instrument, a TV, a personal computer, a personal digital assistant, a voice recorder, a PC card, and an electronic book terminal.

The memory card 100 is supplied with power when it is connected to the host apparatus 200, and operates to execute a process corresponding to an access from the host apparatus 200.

In the flash memory 400, the erase block size (block size of an erasure unit) at a time of erase is set at a predetermined size (e.g. 256 kB). In addition, data write and data read are executed in the flash memory 400 in a unit called “page” (e.g. 2 kB).

The memory controller 300 manages the physical state in the flash memory 400 (e.g. which of numerically ordered logical sector address data is stored at which physical block address, or which block is in an erased state). The memory controller 300 includes a host apparatus interface 301, a CPU (Central Processing Unit) 303, a memory interface (flash interface) 305, a ROM (Read-Only Memory) 307, a RAM (Random Access Memory) 309, a buffer (Buffer) 311, and an ECC core 313.

The host apparatus interface 301 executes an interface process between the host apparatus 200 and the memory controller 300.

The CPU 303 controls the operation of the whole memory card 100. For example, when the memory card 100 is supplied with power, the CPU 303 reads out firmware (control program) from the ROM 307 and loads it in the RAM 309, and then executes a predetermined process, thereby creating various tables in the RAM 309.

In addition, the CPU 303 receives a write command, a read command and an erase command from the host apparatus 200, executes a predetermined process on the flash memory 400, and controls a data transfer process via the buffer 311.

The ROM 307 stores the control programs, etc., which are executed by the CPU 303.

The RAM 309 is used as a working area of the CPU 303 and stores the control programs and various tables.

The memory interface 305 executes an interface process between the memory controller 300 and the flash memory 400.

The buffer 311 temporarily stores a predetermined amount of data (e.g. 1-page data) when data sent from the host apparatus 200 is to be written in the flash memory 400, and temporarily stores a predetermined amount data when data read out of the flash memory 400 is to be sent to the host apparatus 200.

The ECC core 313 generates an ECC parity from data that is sent from the host apparatus 200, when data is to be written in the flash memory 400. When data is to be read out of the flash memory 400, if there is an error between the written data and read-out data, the ECC core 313 detects and corrects the error on the basis of the ECC parity.

When the data read from the flash memory 400 is the data moving process of the flash memory 400, the memory controller in this embodiment omits the error correction process in the case where the number of errors in the read-out data is less than a threshold value, or is a threshold value or less. On the other hand, the memory controller executes the error correction process in the case where the number of errors is the threshold value or more, or is greater than the threshold value.

In the conventional art, when the data moving process in the flash memory 400 is executed, if there are errors in the read-out data, each of the errors is corrected. However, in the present embodiment, if the number of errors is less than a threshold value, or is a threshold value or less, the error correction is omitted. Thereby, for example, compared to the case of correcting each of errors, the number of arithmetic processes that are necessary for error correction and the re-input of data to, e.g. the flash memory 400 for error correction can be reduced. Since the arithmetic processes and the re-input of data are reduced, it is possible to reduce the time that is needed for the data moving process or to suppress an increase in time that is needed for the data moving process.

A more detailed description is given below.

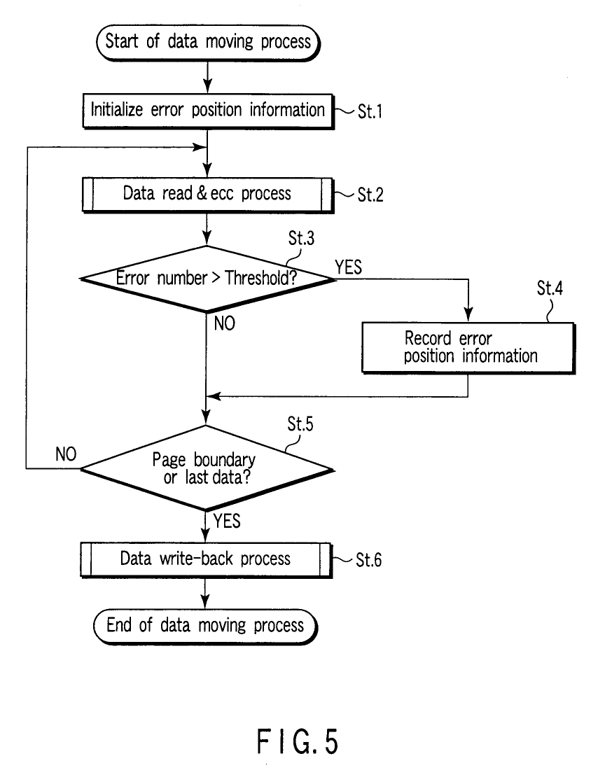

FIG. 4 shows an example of a page format that is used in the memory card.

As shown in FIG. 4, the page format of this example includes a plurality of blocks in one page. In this example, the page format includes an n-number of blocks. The block is a unit corresponding to the number of bits, for which each ECC parity is added.

In the case where the data moving process is performed with use of the page copy command, the write-back process method for the data moving process is executable in two modes. In one mode, data is written back in a batchwise manner in units of the page shown in FIG. 4. In the other mode, data is written back individually in units of the block shown in FIG. 4. These two methods will be described below.

### First Example

### Page-Unit Batch Write-Back

FIG. 5 is a flow chart illustrating a first example of the data moving process sequence which is executed by the memory controller according to the first embodiment of the invention.

As shown in FIG. 5, to start with, error position information is initialized (St. 1). The error position information may be recorded, for example, in the RAM 309 shown in FIG. 3. In this case, of the memory areas of the RAM 309, a memory area which stores error position information may be initialized (cleared).

Next, the block-unit data shown in FIG. 4 and the ECC parity of the block-unit data are read out from the flash memory 400 to the memory interface 305. The memory interface 305 transfers the block-unit data to the buffer 311 and transfers the block-unit data and the associated parity to the ECC core 313. The buffer 311 temporarily stores the block-unit data. The ECC core 313 subjects the transferred block-unit data to the ECC process on the basis of the associated ECC parity (St. 2).

Subsequently, on the basis of the result of the ECC process, the ECC core 313 determines whether the number of detected errors exceeds the threshold value (error number>threshold) (St. 3). This determination may not be executed by the ECC core 313, but may be executed by a comparison circuit which is additionally provided in the memory controller 300 in order to compare the number of errors and the threshold value. Alternatively, the ECC core 313 may determine whether the number of detected errors is a threshold or more (error number≧threshold). These modifications are similarly applicable to a second example to be described later.

If it is determined that the number of errors is the threshold value or less (No), the process advances to St. 5.

If it is determined that the number of errors exceeds the threshold value (Yes), the process advances to St. 4. In St. 4, for example, the ECC core 313 informs the CPU 303 that the number of errors exceeds the threshold value. Upon receiving the information, the CPU 303 temporarily halts the process. While the process is being halted, the ECC core 313 records error position information in, for example, the RAM 309 via the CPU 303. The error position information includes a position of a block to be corrected, and a correction symbol number of the block to be corrected. After the recording, the process is resumed and the process advances to St. 5.

Next, in St. 5, it is determined whether the read-out data is a page boundary (page end), or the last data.

If it is determined that the read-out data is neither the page boundary nor the last data (No), the process returns to St. 2, and repeats St. 2 to St. 5.

If it is determined that the read-out data is either the page boundary or the last data (Yes), the process advances to step St. 6.

Next, in step St. 6, the data that is temporarily stored in the buffer 311 is written back, for example, into a page buffer of the flash memory 400. At this time, if there is a block in which error position information is recorded, corrected data of this block is re-input, for example, in the buffer 311. Thereafter, read-out data including the re-input data, which is temporarily stored in the buffer 311, is written back, for example, into the page buffer of the flash memory 400.

Then, the read-out data that is stored in the page buffer is written in the associated page of the memory cell array in the flash memory 400. Thereby, the data moving process for one page is completed.

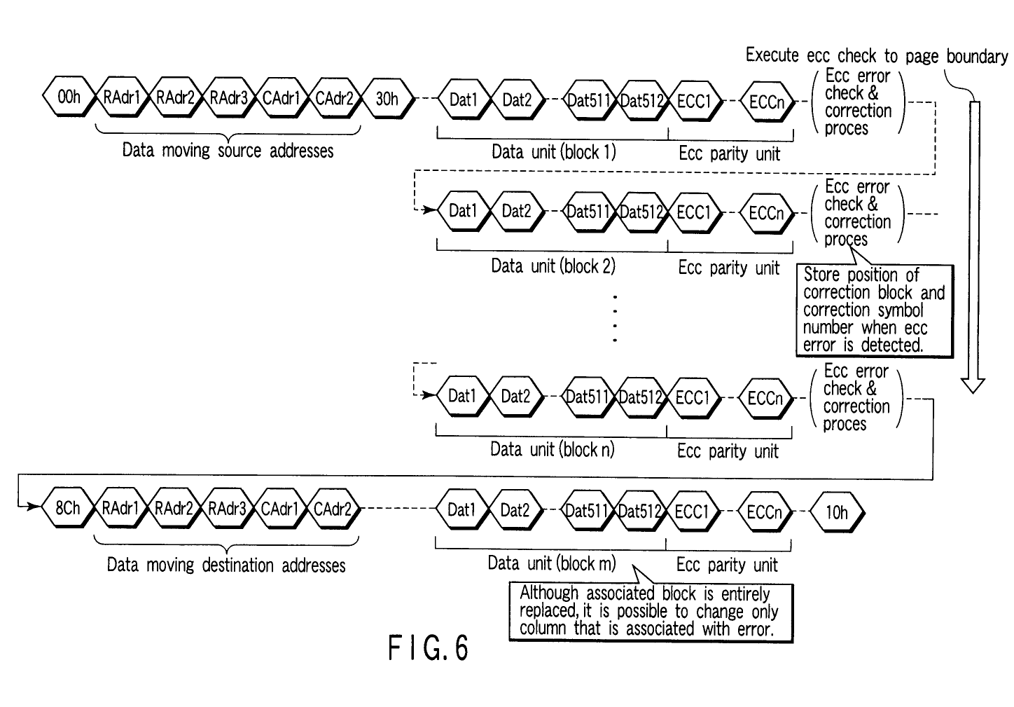

FIG. 6 shows an example of data input/output in the case where the write-back process is executed in units of a page. The data input/output illustrated in FIG. 6 indicates data input/output through the 8-bit IO line 700 between the memory controller 300 and flash memory 400.

In the example shown in FIG. 6, a command 00h is first input, and then data moving source addresses are successively input. After a command 30h is input, data read for one page is started. In this example, the ECC parity is added in units of 512 bytes. The ECC check is executed for every 512 bytes. If a number of errors, which exceeds a threshold value, are present, re-input of data for correction is executed in the buffer 311.

If a command 8Ch is input, a write-back process is started. Following the input of the command 8Ch, data moving destination addresses are successively input. Thereafter, the data that is stored in the buffer 311 is written back to the data moving destination addresses.

In the example of FIG. 6, the associated blocks are entirely replaced. Alternatively, only a column that is associated with an error, may be changed.

### Second Example

### Block-Unit Individual Write-Back

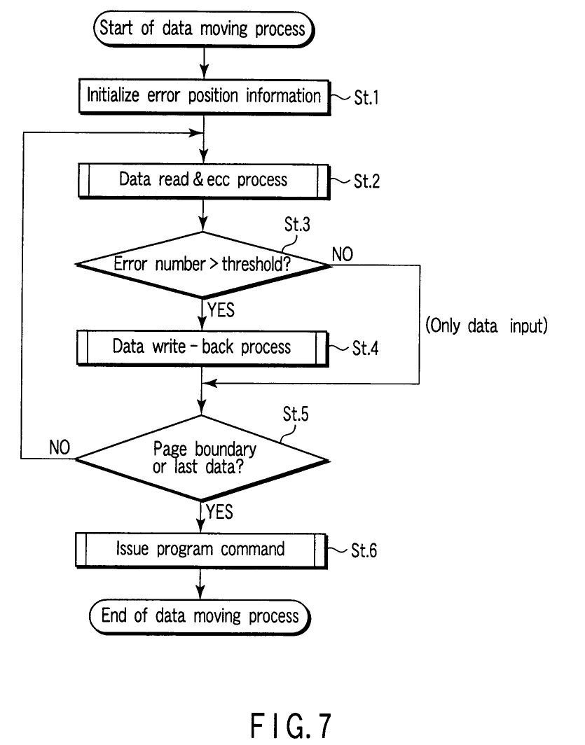

FIG. 7 is a flow chart illustrating a second example of the data moving process sequence which is executed by the memory controller according to the first embodiment of the invention.

As shown in FIG. 7, to start with, like the first example, error position information is initialized (St. 1). The method of recording the error position information may be the same as in the first example.

Next, the block-unit data shown in FIG. 4 and the ECC parity of the block-unit data are read out from the flash memory 400 to the memory interface 305. The memory interface 305 transfers the block-unit data to the buffer 311 and transfers the block-unit data and the associated ECC parity to the ECC core 313. The buffer 311 temporarily stores the block-unit data. The ECC core 313 subjects the transferred block-unit data to the ECC process on the basis of the associated ECC parity (St. 2).

Subsequently, on the basis of the result of the ECC process, the ECC core 313 determines whether the number of detected errors exceeds the threshold value (error number>threshold) (St. 3).

If it is determined that the number of errors is the threshold value or less (No), only the data input to the buffer 311 is executed and the process advances to St. 5.

If it is determined that the number of errors exceeds the threshold value (Yes), the process advances to step St. 4. The corrected data is re-input to the buffer 311. Thereafter, corrected read-out data, which is re-input to the buffer 311, is written back, for example, into the page buffer of the flash memory 400. Then, the process advances to step St. 5.

In step St. 5, it is determined whether the read-out data is a page boundary (page end), or the last data.

If it is determined that the read-out data is neither the page boundary nor the last data (No), the process returns to St. 2, and repeats St. 2 to St. 4.

If it is determined that the read-out data is either the page boundary or the last data (Yes), the process advances to step St. 6.

Next, in step St. 6, for example, the CPU 303 of the memory controller 300 issues a program command to the flash memory 400. Only the data of the error-corrected block is re-input to the flash memory 400. Upon receiving the program command, the read data that is stored in the page buffer of the flash memory 400 is written in the associated page of the memory cell array. Thereby, the data moving process for one page is completed.

### Second Embodiment

In a second embodiment of the invention, the threshold is made variably settable in accordance with purposes. In this embodiment, in particular, the threshold is varied depending on whether the data read is a data moving process or not.

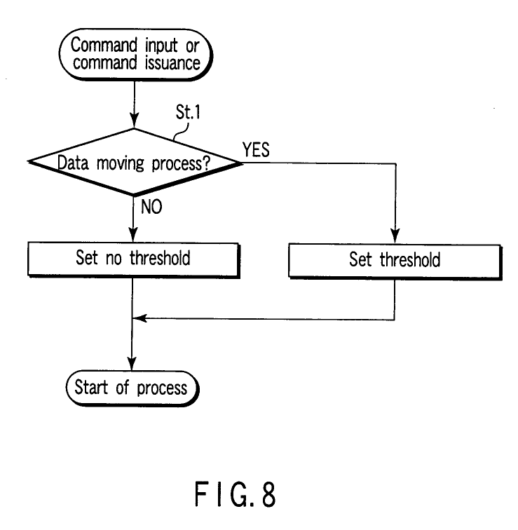

FIG. 8 is a flow chart illustrating an example of a threshold variable-setting sequence which is executed by a memory controller according to the second embodiment of the invention.

As shown in FIG. 8, assume now that a command has been input to the CPU 303 or the CPU 303 has issued a command.

In step St. 1, it is determined whether the input command or the issued command is the data moving process or not.

If it is determined that neither the input command nor the issued command is the data moving process (No), the threshold value is not set and a process according to the command is started.

If it is determined that either the input command or the issued command is the data moving process (Yes), the threshold value is set and then a process according to the command is started.

As has been described above, if the threshold value is made variably settable in accordance with purposes, that is, if the threshold is set only in the case of the data moving process, for example, as in the present embodiment, data that is in the correctable range is corrected and output, without interruption, in the data read process for the host. In short, if there is an error, the error is corrected and then the error-corrected data can be sent to the host.

Thus, even in the case of adopting the process sequence of the first embodiment in which the memory controller tolerates data with errors, without correcting the errors, if the number of errors does not exceed the threshold value, data can be sent to the host after errors are corrected, in the data read process for the host. Therefore, the read performance with high reliability can be ensured.

### Third Embodiment

There is known a nonvolatile semiconductor memory, for example, a NAND-type flash memory, in which even if there is an error between data written in a page buffer and data actually written in memory cells, write failure (fail) is not determined but write success (pass) is determined if the number of errors is less than a predetermined value or the number of errors is a predetermined value or less. This function is generally called “pseudo-pass function”.

In an example of the nonvolatile semiconductor memory with the pseudo-pass function, for example, in the case where the memory controller can execute 4-symbol error detection/correction, if the number of errors is, e.g. up to “1”, write success (pass) is determined. In this case, the number of errors which is tolerated as “pseudo-pass” by the nonvolatile semiconductor memory (hereinafter referred to as “pseudo-pass upper-limit value”) is “1”.

On the other hand, in the case where the memory controller can execute 8-symbol error detection/correction, if the number of errors is, e.g. up to “4”, write success (pass) is determined. In this case, the pseudo-pass upper-limit value is “4”.

In the case where the memory controller controls the nonvolatile semiconductor memory having the pseudo-pass function, it is better to set the threshold value of the memory controller at a value which is the pseudo-pass upper-limit value or more. The reason is that if the threshold value of the memory controller is set at a value which is less than the pseudo-pass upper-limit value, it is possible that correction processes frequently occur in the data moving process.

Thus, in the memory controller according to the third embodiment, when the nonvolatile semiconductor memory has the pseudo-pass function, the threshold value of the memory controller is set at a value which is the pseudo-pass upper-limit value or more.

Thereby, even when the nonvolatile semiconductor memory has the pseudo-pass function, it becomes possible to decrease the possibility that correction processes frequently occur in the data moving process.

In addition, it is better to set the upper-limit value of the threshold of the memory controller at a value less that the error detection/correction performance of the ECC core. For example, in the case where the ECC core can execute 4-symbol error detection/correction, the upper-limit value of the threshold value is set at “3” so that the number of errors may have a margin of “1”. This margin is provided in consideration of the possibility of occurrence of an error after the end of the data moving process. For example, in the case where the ECC core can execute 4-symbol error detection/correction, the upper-limit value of the threshold value may be set at “4”. However, in the case where the upper-limit value is set at “4”, if even one error occurs after the data moving process, the error detection/correction would be beyond the error detection/correction performance of the ECC core. In this case, the ECC core cannot execute the error detection/correction.

Thus, in the memory controller of the third embodiment, the upper-limit value of the threshold value is set at a value less than the error detection/correction performance of the ECC core.

Thereby, even if an error occurs after the data moving process, the ECC core can detect and correct this error.

As regards examples of error correction codes, the higher the error detection/correction performance, the better it is, since a higher upper-limit value of the threshold value can be set and a greater margin of the number of errors can be set. Error correction codes, which satisfy this condition, are, e.g. Reed-Solomon codes and BCH codes. The BCH code is advantageous in correcting discrete errors.

As has been described above, the embodiment can provide a memory controller which can decrease the time that is needed for the data moving process, or can suppress an increase of the time that is needed for the data moving process.

The above-described embodiments include the following aspects:

(1) A memory controller which is connectable to a memory and controls the memory, comprising:

a memory interface to which read-out data from the memory and an ECC parity of the read-out data are input;

an ECC core to which the read-out data and the ECC parity are input from the memory interface, and which generates, on the basis of the ECC parity, information of presence/absence of an error in the read-out data and correction information of the error; and

a buffer to which the correction information and the read-out data from the memory interface are input, and executes a correction process of correcting the read-out data in accordance with the correction information in a case where the error is present in the read-out data,

wherein when data-read from the memory is a data moving process in the memory, the correction process is omitted in a case where a number of the errors is less than a threshold value or the threshold value or less, and the correction process is executed in a case where the number of the errors is the threshold value or more, or greater than the threshold value.

### (2) The memory controller according to (1), wherein the threshold value is variably settable.

(3) The memory controller according to (2), wherein when the data-read from the memory is a data read process for a host, the correction process is executed despite the number of the errors being less than the threshold value or the threshold value or less, and the read-out data, which has been subjected to the correction process, is output to the host.

### (4) The memory controller according to any one of (1) to (3), wherein when the memory has a pseudo-pass function, the threshold value is set at a value which is a pseudo-pass upper-limit value or more of the memory.

### (5) The memory controller according to any one of (1) to (4), wherein an upper-limit value of the threshold value is set at a value less than an error detection/correction performance of the ECC core.

### (6) The memory controller according to any one of (1) to (5), wherein an error detection/correction code of the ECC core is a Reed-Solomon code.

The present invention has been described with reference to some embodiments, but the invention is not limited to the embodiments. The invention can be variously modified, in practice, without departing from the spirit of the invention.

Each of the embodiment can be practiced independently, but the embodiments may properly be combined and practiced.

Each of the embodiments includes inventions in various stages, and inventions in various stages can be derived from proper combinations of structural elements disclosed in each embodiment.

In the above-described embodiments, the invention is applied to the controller that controls the nonvolatile semiconductor memory. However, the invention is not limited to the memory controller, and the invention covers semiconductor integrated circuit devices incorporating the controller, such as processors, system LSIs, etc.

The NAND-type flash memory has been described as an example of the nonvolatile semiconductor memory. However, the nonvolatile semiconductor memory that is controlled by the memory controller according to the above-described embodiments is not limited to the NAND-type flash memory, and may be an AND-type flash memory, a NOR-type flash memory, etc., other than the NAND-type flash memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory controller which is connectable to a memory and controls the memory, comprising:
a memory interface to which read-out data from the memory and an ECC parity of the read-out data are input;
an ECC core to which the read-out data and the ECC parity are input from the memory interface, and which generates, on the basis of the ECC parity, information of presence/absence of an error in the read-out data and correction information of the error; and
a buffer to which the correction information and the read-out data from the memory interface are input, and executes a correction process of correcting the read-out data in accordance with the correction information in a case where the error is present in the read-out data,
wherein when data-read from the memory is a data moving process in the memory, the correction process is omitted in a case where a number of the errors is less than a threshold value or the threshold value or less, and the correction process is executed in a case where the number of the errors is the threshold value or more, or greater than the threshold value.

2. The memory controller according to claim 1, wherein the threshold value is variably settable.

3. The memory controller according to claim 2, wherein when the data-read from the memory is a data read process for a host, the correction process is executed despite the number of the errors being less than the threshold value or the threshold value or less, and the read-out data, which has been subjected to the correction process, is output to the host.

4. The memory controller according to claim 1, wherein when the memory has a pseudo-pass function, the threshold value is set at a value which is a pseudo-pass upper-limit value or more of the memory.

5. The memory controller according to claim 1, wherein an upper-limit value of the threshold value is set at a value less than an error detection/correction performance of the ECC core.

6. The memory controller according to claim 1, wherein an error detection/correction code of the ECC core is a Reed-Solomon code.

7. The memory controller according to claim 1, wherein an error detection/correction code of the ECC core is a BCH code.

8. A semiconductor memory device comprising:
a memory; and
a memory controller which is connectable to the memory and controls the memory,
the memory controller comprising:
a memory interface to which read-out data from the memory and an ECC parity of the read-out data are input;
an ECC core to which the read-out data and the ECC parity are input from the memory interface, and which generates, on the basis of the ECC parity, information of presence/absence of an error in the read-out data and correction information of the error; and
a buffer to which the correction information and the read-out data from the memory interface are input, and executes a correction process of correcting the read-out data in accordance with the correction information in a case where the error is present in the read-out data,
wherein when data-read from the memory is a data moving process in the memory, the correction process is omitted in a case where a number of the errors is less than a threshold value or the threshold value or less, and the correction process is executed in a case where the number of the errors is the threshold value or more, or greater than the threshold value.

9. The device according to claim 8, wherein the threshold value is variably settable.

10. The device according to claim 9, wherein when the data-read from the memory is a data read process for a host, the correction process is executed despite the number of the errors being less than the threshold value or the threshold value or less, and the read-out data, which has been subjected to the correction process, is output to the host.

11. The device according to claim 8, wherein when the memory has a pseudo-pass function, the threshold value is set at a value which is a pseudo-pass upper-limit value or more of the memory.

12. The device according to claim 8, wherein an upper-limit value of the threshold value is set at a value less than an error detection/correction performance of the ECC core.

13. The device according to claim 8, wherein an error detection/correction code of the ECC core is a Reed-Solomon code.

14. The device according to claim 8, wherein an error detection/correction code of the ECC core is a BCH code.
